(19) United States
(12) Patent Application Publication
(10) Pub. No.: US 2025/0368348 A1
(43) Pub. Date: Dec. 4, 2025

(54) AN AIRCRAFT ASSEMBLY

(71) Applicant: AIRBUS OPERATIONS LIMITED, Bristol (GB)

(72) Inventors: Samuel PHILLIPS, Bristol (GB); Anthony BRYANT, Bristol (GB)

(21) Appl. No.: 18/874,945

(22) PCT Filed: Jun. 14, 2023
(86) PCT No.: PCT/GB2023/051549

§ 371 Date: Dec. 13, 2024

(30) Foreign Application Priority Data
Jun. 14, 2022 (GB) 2208677.1
Jun. 14, 2022 (GB) 2208699.5
Sep. 27, 2022 (GB) 2214062.8

(51) Int. Cl. B64D 37/30; B64D 37/00; F16L 39/04

(52) U.S. Cl. CPC B64D 37/30; B64D 37/005; F16L 39/04

(57) ABSTRACT

An aircraft assembly is disclosed including a wing structure, and a pipe assembly rotatably coupled to the wing structure by a fixture arrangement. The pipe assembly extends along a longitudinal direction, the fixture arrangement configured to restrict movement of at least a portion of the pipe assembly in the longitudinal direction relative to the wing structure and allow rotation of the pipe assembly relative to the wing structure.

### FIELD OF THE INVENTION

The present invention relates to an aircraft assembly, an aircraft wing comprising the aircraft assembly, and an aircraft comprising the aircraft wing.

### BACKGROUND OF THE INVENTION

Aircraft wings undergo various bending and twisting in service. Fuel pipes that extend along on the wings are typically fastened to the ribs, thereby securing the pipes in position relative to the ribs. By securing the pipes to the ribs, the pipes similarly undergo bending and twisting in accordance with the wing. However, the pipes resist such movement and transfer the resulting loads into the ribs. These loads need to be accounted for when designing the ribs.

This is further exacerbated when the fuel pipes convey hydrogen, as the cryogenic temperatures mean that the fuel pipes are typically larger in thickness and this can further increase the loads transferred to the ribs.

### SUMMARY OF THE INVENTION

A first aspect of the invention provides an aircraft assembly comprising: an aircraft structure; and a pipe assembly rotatably coupled to the aircraft structure by a fixture arrangement, the pipe assembly extending along a longitudinal direction, the fixture arrangement configured to restrict movement of at least a portion of the pipe assembly in the longitudinal direction relative to the aircraft structure and allow rotation of the pipe assembly relative to the aircraft structure, wherein the pipe assembly comprises an outer pipe section and an inner pipe section, and the inner pipe section is enveloped by the outer pipe section.

The fixture arrangement couples a double-walled pipe assembly (that is, a pipe assembly comprising an inner pipe section enveloped by an outer pipe section) to the aircraft structure, whilst allowing rotation of the pipe assembly relative to the aircraft structure.

The fixture arrangement may be configured to allow rotation of the pipe assembly, relative to the aircraft structure, about a longitudinal axis extending in the longitudinal direction. With this arrangement, twisting of the aircraft (for instance twisting of the aircraft wing) is accounted for at the pipe assembly. This can prevent substantial loads being transferred from the pipe assembly to the aircraft structure.

The fixture arrangement may be configured to allow rotation of the pipe assembly, relative to the aircraft structure, about a transverse axis extending perpendicular to the longitudinal direction.

The fixture arrangement may be configured to allow rotation of the pipe assembly, relative to the aircraft structure, about two perpendicular axes. The fixture arrangement may be configured to allow rotation of the pipe assembly, relative to the aircraft structure, about three perpendicular axes. With either of these arrangements, the range of movement that is accounted for by the fixture arrangement is increased.

The aircraft assembly may comprise curved bearing surfaces forming a bearing therebetween so as to allow rotation of the pipe assembly relative to the aircraft structure. This is one way in which relative rotation of the pipe assembly with respect to the aircraft structure can be achieved.

Optionally the bearing surfaces are correspondingly curved bearing surfaces. For instance the curved bearing surfaces may both be cylindrical or they may both be spherical.

The bearing surfaces may be formed by a protruding portion and a recessed portion. This can help to increase the distance between the aircraft structure and the pipe assembly, so as to decrease thermal transfer therebetween.

Optionally the fixture arrangement comprises a spherical bearing, the spherical bearing comprising a ball mounted to the pipe assembly, and a housing coupled to the aircraft structure; wherein the ball comprises a convex spherical bearing surface; and the housing comprises a concave spherical bearing surface which mates with the convex spherical bearing surface of the ball.

Optionally the ball comprises an assembly of two or more ball parts which are distributed around a circumference of the pipe assembly.

Optionally the pipe assembly comprises a pair of flanges on opposite sides of the ball. Optionally the pair of flanges are also on opposite sides of the aircraft structure. Optionally a gap is provided between each flange and the ball. Optionally each gap is less than 10 mm or less than 5 mm. Alternatively the pair of flanges may contact the ball, to axially constrain the ball.

Optionally the pipe assembly comprises a pair of flanges on opposite sides of the aircraft structure.

Optionally the pipe assembly passes through an aperture in the aircraft structure.

Optionally at least one of the flanges has a diameter greater than a diameter of the aperture in the aircraft structure.

If the fixture arrangement comprises a spherical bearing, then at least one of the failsafe flanges may have a diameter greater than a diameter of the convex spherical bearing surface.

Optionally the pipe assembly comprises a sleeve mounted to the outer pipe section, wherein the sleeve provides one of the bearing surfaces.

Optionally the sleeve comprises a substantially electrically non-conductive material, configured to electrically isolate the fixture arrangement from the outer pipe section. This ensures there is no metal-to-metal contact between the fixture arrangement and the outer pipe section, and thereby provides lightning strike protection. The material may be an electrically non-conductive polymer material. The polymer material may be lighter than an equivalent metal component but is typically less stiff. However, the reduced loads transferred to the aircraft structure make a polymer material suitable.

Optionally the bearing surfaces can slide relative to each other to allow rotation of the pipe assembly relative to the aircraft structure about a longitudinal axis extending in the longitudinal direction.

Optionally the bearing surfaces are shaped to restrict rotation of the pipe assembly relative to the aircraft structure about two axes perpendicular to the longitudinal direction.

Optionally one of the bearing surfaces, or each bearing surface, comprises a substantially electrically non-conductive material configured to isolate the aircraft structure from the pipe assembly, thereby providing lightning strike protection. The material may be an electrically non-conductive polymer material. The polymer material may be lighter than an equivalent metal component but is typically less stiff. However, the reduced loads transferred to the aircraft structure make a polymer material suitable.

Optionally the bearing surfaces are shaped to provide stop features which restrict movement of at least a portion of the pipe assembly in the longitudinal direction relative to the aircraft structure.

In one embodiment each bearing surface comprises a set of ridges spaced apart in the longitudinal direction, and the sets of ridges interlock with each other to restrict movement of at least a portion of the pipe assembly in the longitudinal direction relative to the aircraft structure.

Optionally the bearing surfaces each have a generally cylindrical shape which allows rotation of the pipe assembly relative to the aircraft structure about a longitudinal axis extending in the longitudinal direction, and which restricts rotation of the pipe assembly relative to the aircraft structure about two perpendicular axes, wherein the two perpendicular axes are perpendicular to each other and perpendicular to the longitudinal axis.

Optionally the pipe assembly is configured to convey hydrogen fuel. The low temperatures required for hydrogen fuels necessitate a thickening of the fuel pipes and/or contraction of the pipes that can increase the loads that may otherwise be transferred to the ribs.

Optionally the inner pipe section is configured to convey hydrogen fuel. This allows the space between the inner and outer pipe sections to act as a thermal barrier.

Optionally the hydrogen fuel is liquid hydrogen fuel.

Optionally the hydrogen fuel is gaseous hydrogen.

Optionally the inner pipe section is spaced from the outer pipe section. This ensures no contact is made between the pipe sections, and thereby reduces heat transfer therebetween.

Optionally the space between the inner pipe section and outer pipe section comprises a vacuum or an inert gas.

Optionally the fixture arrangement comprises a substantially electrically non-conductive material configured to isolate the aircraft structure from the pipe assembly. Preferably the material is a polymer material.

The fixture arrangement may be configured to restrict movement of a first rigid pipe section of the pipe assembly in the longitudinal direction relative to the aircraft structure, whilst allowing movement of a second rigid pipe section of the pipe assembly in the longitudinal direction relative to the aircraft structure. Alternatively the fixture arrangement may be configured to restrict movement of all portions of the pipe assembly in the longitudinal direction relative to the aircraft structure.

Optionally the fixture arrangement is configured to restrict movement of the pipe assembly in the longitudinal direction relative to the aircraft structure.

Optionally the pipe assembly comprises one or more stop members configured to engage with the fixture arrangement to restrict movement of at least a portion of the pipe assembly in the longitudinal direction relative to the aircraft structure.

Optionally the (or each) stop member is fixed to the outer pipe section, for example by welding or bonding or by being formed integrally with the outer pipe section.

Optionally the one or more stop members comprises a first stop feature configured to engage with a first part of the fixture arrangement to restrict movement of at least a portion of the pipe assembly in the longitudinal direction relative to the aircraft structure in a first direction, and a second stop feature configured to engage with a second part of the fixture arrangement to restrict movement of at least a portion of the pipe assembly in the longitudinal direction relative to the aircraft structure in a second direction.

Optionally the first stop feature comprises a first flange and the second stop feature comprises a second flange.

Optionally the one or more stop members comprise a protrusion or recess, the first stop feature comprises a first side of the protrusion or recess and the second stop feature comprises a second side of the protrusion or recess.

Optionally the aircraft structure is a rib with an aperture in the rib; and the pipe assembly extends through the aperture.

Optionally each pipe section extends through the aperture, and the fixture arrangement is configured to restrict movement of the pipe sections in the longitudinal direction relative to the rib and allow rotation of the pipe sections relative to the rib.

The pipe assembly may be continuous across the rib. Couplings and other arrangements not integrally formed are generally undesirable as they increase the risk of leakage. This is particularly the case for cryogenic pipes, which ideally avoid any seals between pipe sections.

Optionally the fixture arrangement is configured to restrict movement of at least a portion of the pipe assembly in the longitudinal direction relative to the aircraft structure with play no greater than 10 mm, or with play no greater than 5 mm, or with play no greater than 2 mm, or with play no greater than 1 mm.

The fixture arrangement may comprise a substantially electrically non-conductive material configured to isolate the aircraft structure from the pipe assembly, thereby providing lightning strike protection. The material may be an electrically non-conductive polymer material. The polymer material may be lighter than an equivalent metal component but is typically less stiff. However, the reduced loads transferred to the aircraft structure make a polymer material suitable.

A second aspect of the invention provides an aircraft assembly comprising: a rib of a wing; an aperture in the rib; a pipe assembly extending through the aperture and rotatably coupled to the rib by a fixture arrangement, the pipe assembly extending along a longitudinal direction, the fixture arrangement configured to restrict movement of at least a portion of the pipe assembly in the longitudinal direction relative to the rib and allow rotation of the pipe assembly relative to the rib, wherein the pipe assembly comprises an outer pipe section and an inner pipe section, and the inner pipe section is enveloped by the outer pipe section.

With this arrangement, relative rotation of the pipe assembly either side of the wing rib is permitted, thereby reducing or mitigating the loads transferred to the wing rib. Locating the fixture arrangement at the rib ensures maximum moveability of the pipe assembly either side of the rib.

A third aspect of the invention provides an aircraft wing comprising the aircraft assembly of the first or second aspect.

The aircraft wing may comprise a plurality of aircraft assemblies according to the first or second aspect.

A fourth aspect of the invention provides an aircraft comprising the aircraft wing of the third aspect.

### BRIEF DESCRIPTION OF THE DRAWINGS

Embodiments of the invention will now be described with reference to the accompanying drawings, in which:

FIG. 1 shows an aircraft;

FIG. 2 is a sectional view of a wing box of the starboard wing;

FIG. 3 shows the wing box extending along a wing;

FIG. 4 shows a rib;

FIG. 5 shows a first example of an aircraft assembly;

FIG. 6 shows a cross-sectional view of the aircraft assembly of the first example;

FIG. 7 shows a second example of an aircraft assembly;

FIG. 8 shows a cross-sectional view of the aircraft assembly of the second example;

FIG. 9 shows a third example of an aircraft assembly;

FIG. 10 shows a cross-section of the aircraft assembly of the third example;

FIG. 11 shows a first example of a fuel pipe extending through a series of ribs of an aircraft wing;

FIG. 12 shows a second example of a fuel pipe extending through a series of ribs of an aircraft wing;

FIG. 13 shows a cross-sectional view of a fourth example of an aircraft assembly, taken along a section line A-A in FIG. 18;

FIG. 14 is an enlarged view showing the bearing surfaces of the fourth example;

FIG. 15 shows the two halves of the fixture arrangement of the fourth example;

FIG. 16 is an isometric view showing the assembly of the fourth example without the rib.

FIG. 17 is a left view of the assembly of the fourth example;

FIG. 18 is a front view of the assembly of the fourth example;

FIG. 19 shows a cross-sectional view of a fifth example of an aircraft assembly, taken along a section line A-A in FIG. 24;

FIG. 20 is an enlarged view showing the bearing surfaces of the fifth example;

FIG. 21 shows the two halves of the fixture arrangement of the fifth example;

FIG. 22 is an isometric view showing the assembly of the fifth example without the rib.

FIG. 23 is a left view of the assembly of the fifth example;

FIG. 24 is a front view of the assembly of the fifth example;

FIG. 25 shows a sixth example of an aircraft assembly;

FIG. 26 is a transverse cross-sectional view through the sixth example of the aircraft assembly;

FIG. 27 is a front view of the sixth example of the aircraft assembly;

FIG. 28 is a longitudinal cross-sectional view through the sixth example of the aircraft assembly, taken along a section line A-A in FIG. 27;

FIG. 29 is a schematic view showing a pipe assembly passing through five wing ribs;

FIG. 30 is a schematic view showing a series of pipe assemblies passing through fifteen wing ribs;

FIG. 31 is a schematic view showing a pipe assembly passing through five wing ribs;

FIG. 32 shows a fixture arrangement at an inboard rib;

FIG. 33 is a cross-sectional view of the fixture arrangement of FIG. 32;

FIG. 34 is an enlarged cross-sectional view of the fixture arrangement of FIG. 32;

FIG. 35 is an end view of the fixture arrangement, viewed in the longitudinal direction; and

FIG. 36 is an isometric view of the fixture arrangement, partly in cross-section, showing an aperture in the inboard rib.

### DETAILED DESCRIPTION OF EMBODIMENT(S)

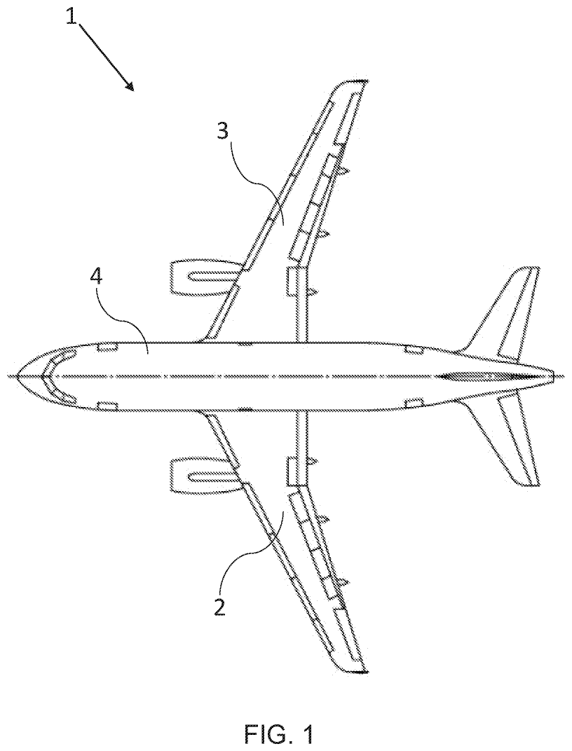

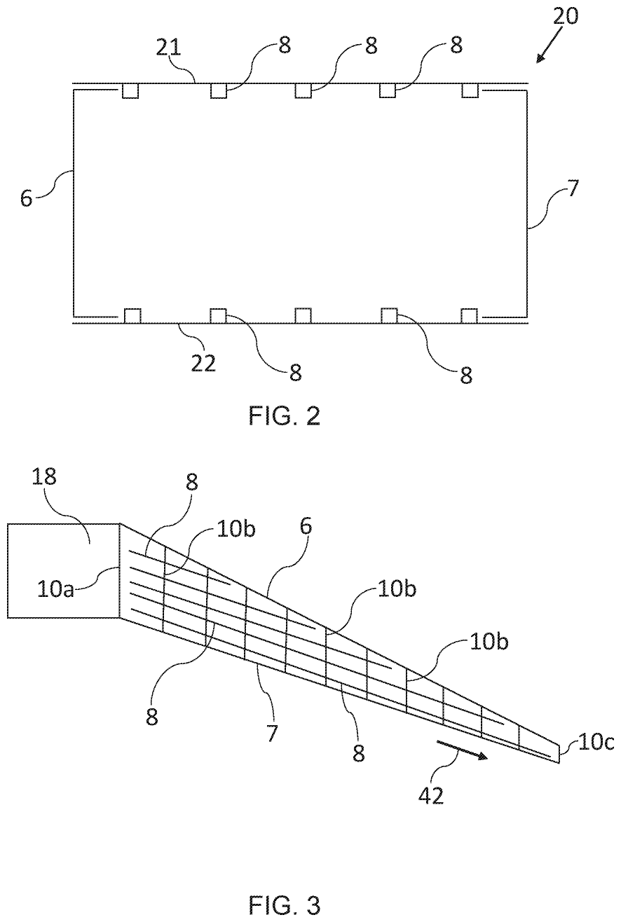

FIG. 1 shows an aircraft 1 with port and starboard wings 2, 3. Each wing has a cantilevered structure with a length extending in a generally spanwise direction 42 from a root to a tip (shown in FIG. 3), the root being joined to an aircraft fuselage 4. The wings 2, 3 are similar in construction so only the starboard wing 3 will be described in detail with reference to FIGS. 2 and 3.

The main structural element of the wing 3 is a wing box 20 that may be formed by upper and lower covers 21, 22 and front and rear spars 6, 7 shown in cross-section in FIG. 2. The covers 21, 22 and spars 6, 7 may each be formed of Carbon Fibre Reinforced Polymer (CFRP) laminate components. Each cover 21, 22 comprises a panel assembly and may have a curved aerodynamic outer surface (e.g. the upper surface of the upper cover 21 and the lower surface of the lower cover 22) over which air flows during flight of the aircraft 1. Each cover 21, 22 has an inner surface carrying a series of stiffeners 8 extending in the spanwise direction 42 (only some of the stiffeners 8 are labelled so as to improve the clarity of the figures). Each stiffener 8 is joined to one cover 21, 22 but not the other.

It will be understood that any number of stiffeners 8 may be applied across the chord of the wing 3, although only five are shown coupled to each cover 21, 22 in FIGS. 2 and 3 for the purposes of clarity.

The wing box 20 may have a plurality of transverse ribs, each rib being joined to the covers 21, 22 and the spars 6, 7. The ribs 10 may include an inner-most inboard rib 10a located at the root of the wing box 20, an outer-most rib 10c at the tip of the wing box 20, and one or more mid-span ribs 10b between the inner-most and outer-most ribs 10a, 10c. The inner-most rib 10a may be an attachment rib which forms the root of the wing box 20 and is joined to a centre wing box 18 within the body of the fuselage 4. Each rib 10a, 10b, 10c may connect the upper cover 21 to the lower cover 22. The stiffeners 8 may pass through rib recesses (not shown) in the ribs 10b.

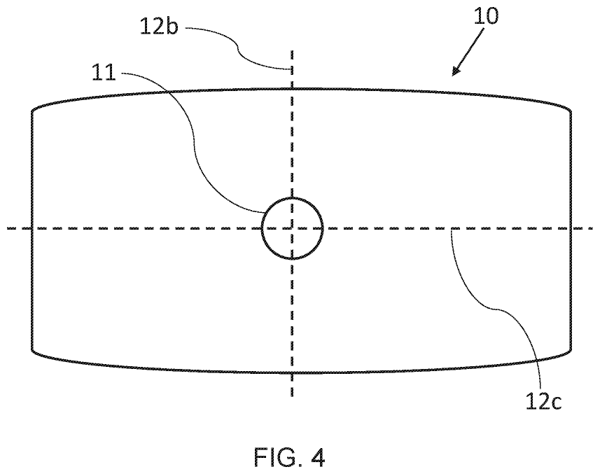

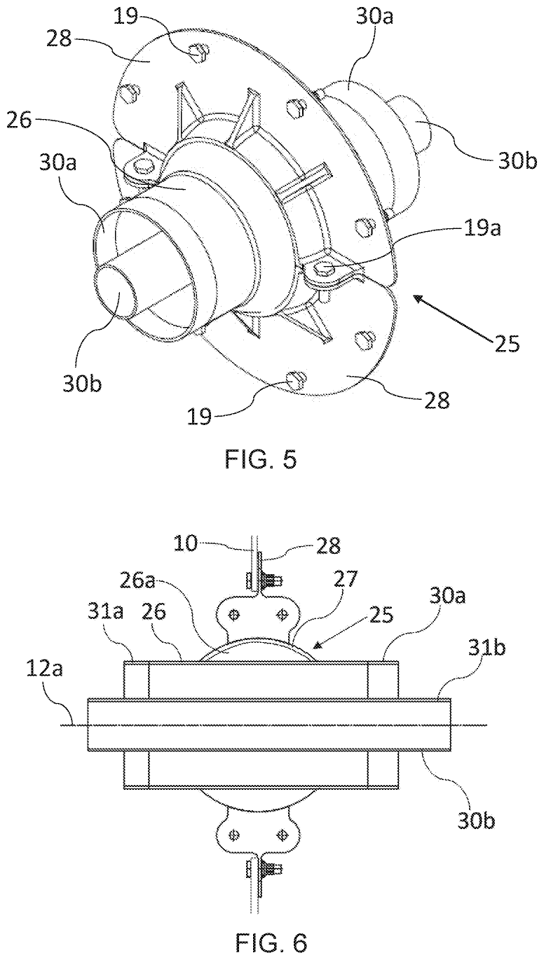

An aperture 11 is formed in one or more of the ribs 10, such as shown in FIG. 4. A pipe assembly 30a, 30b extends through the aperture 11 so that a longitudinal axis of the pipe assembly extends through the aperture 11. As shown in FIG. 5, the pipe assembly is a double-walled pipe assembly comprising an outer pipe assembly 30a and an inner pipe section 30b enveloped by the outer pipe assembly 30a.

The outer pipe assembly 30a comprises a rigid outer pipe section 31a, and a sleeve 26. As shown in FIG. 6, the rigid outer pipe section 31a extends either side of a plane of the rib 10. The rigid outer pipe section 31a may be formed of metal e.g. stainless steel. The rigid outer pipe section 31a may have a constant thickness and diameter.

The inner pipe section 30b comprises a rigid inner pipe section 31b extending either side of a plane the rib 10. The rigid inner pipe section 31b may be formed of metal e.g. stainless steel. The rigid inner pipe section 31b may have a constant thickness and diameter. The rigid inner pipe section 31b is enveloped by the outer pipe section 31a.

The outer pipe assembly 30a is rotatably coupled to the rib 10 by a fixture arrangement 25, as shown in FIGS. 5 and 6. The fixture arrangement 25 may be located at a plane of the rib 10.

To fix the outer pipe section 31a of the outer pipe assembly 30a to the rib 10, the fixture arrangement 25 comprises a flange 28 that is fixed to the rib 10 with one or more fasteners 19. It will be appreciated that the rib 10 may be integrally formed with the fixture arrangement 25.

The sleeve 26 is fixedly attached to an outer surface of the rigid outer pipe section 31a, for instance by a weld or a layer of adhesive (not shown). The sleeve 26 extends across at least a portion of the outer pipe assembly 30a. The sleeve 26 may comprise a protruding portion 26a, with the protruding portion 26a arranged to rotatably couple to a correspondingly recessed portion 27 of the fixture arrangement 25. Alternatively, the sleeve 26 may comprise a recessed portion 27 corresponding to a protruding portion 26a of the fixture arrangement 25. The protruding portion 26a and the recessed portion 27 have corresponding curved profiles.

The fixture arrangement 25 may comprise a substantially electrically non-conductive material, e.g. the material may be a non-conductive polymer material. This helps to isolate the pipe assembly 30a, 30b from the rib 10 so that no metal-to-metal contact is formed. This helps to mitigate the effects of lightning strikes.

The fixture arrangement 25 restricts movement of the outer pipe section 31a in the longitudinal direction relative to the rib 10 and allows rotation of the pipe assembly 30a, 30b relative to the rib 10. In particular, the protruding portion 26a and the corresponding recessed portion 27 may have correspondingly spherically curved bearing surfaces forming a spherical bearing therebetween to allow relative rotation of the pipe assembly 30a, 30b relative to the rib 10. A spherical bearing between the protruding portion 26a and the recessed portion 27, for example as shown in FIG. 5, allows rotation of the pipe assembly 30a, 30b relative to the rib 10 about three perpendicular axes 12a, 12b, 12c. The bearing surfaces can slide relative to each other to allow this rotation of the pipe assembly.

As well as enabling rotation of the pipe assembly, the bearing surfaces also perform the function of restricting movement of the pipe assembly in the longitudinal direction relative to the rib 10, due to their spherical shape. Thus the protruding portion 26a acts as a stop member configured to engage with the fixture arrangement 25 to restrict movement of the pipe assembly 30a, 30b in the longitudinal direction relative to the wing structure. More specifically, the right-hand side of the protruding portion 26a acts as a first stop feature configured to engage with a first part of the fixture arrangement (the right-hand side of the recess 27) to restrict movement of the pipe assembly to the right, in the view of FIG. 6. Similarly the left-hand side of the protruding portion 26a acts as a second stop feature configured to engage with a second part of the fixture arrangement (the left-hand side of the recess 27) to restrict movement of the pipe assembly to the left.

Depending on the fit between the bearing surfaces, a certain amount of play may be permitted in the longitudinal direction. The fixture arrangement 25 may be configured to restrict movement of at least a portion of the pipe assembly in the longitudinal direction relative to the wing structure with play no greater than 10 mm, or with play no greater than 5 mm, or with play no greater than 2 mm, or with play no greater than 1 mm.

The rotation of the pipe assembly 30a, 30b, relative to the rib 10, allows loads acting on the wing 3 to be accounted for. In particular, bending of the wing 3 may cause the outer pipe assembly 30a to clash with the edge of the aperture 11 if the distance of the outer pipe assembly 30a from the edge of the aperture 11 is not maintained by the fixture arrangement 25. If the pipe assembly were fixed to the rib 10, twisting and/or bending of the wing 3 may cause significant loads to be transferred from the pipe assembly 30a, 30b to the rib 10, and thereby require additional strengthening of the rib 10.

By permitting rotation of the pipe assembly 30a, 30b about the longitudinal axis 12a of the pipe assembly 30a, 30b and/or about one or more of the perpendicular axes 12b, 12c in a plane of the rib 10, the loads transferred from the pipe assembly 30a, 30b due to twisting and/or bending of the wing 3 are reduced or mitigated.

Meanwhile, by restricting movement of the outer pipe assembly 30a along the longitudinal axis 12a, the outer pipe assembly 30a is prevented from sliding freely through the wing box 20.

The pipe assembly 30a, 30b may be configured to convey a fuel, for example a petroleum based fuel such as kerosene, or a hydrogen fuel.

The cryogenic temperatures required for the storage of hydrogen fuels, in contrast to the temperature of the surrounding wing box 20, may give rise to additional loads acting on the pipe assembly 30a, 30b that can be reduced or mitigated by the fixture arrangement 25. In particular, the cryogenic temperatures may cause the pipe assembly 30a, 30b to contract. If the pipe assembly 30a, 30b was fixed to the rib 10, these loads could be transferred to the rib 10, and thereby necessitate additional reinforcement of the rib 10.

In examples in which the pipe assembly 30a, 30b is configured to convey hydrogen fuel, the use of a double-walled pipe arrangement can be particularly advantageous. In particular, the inner pipe section 30b may be configured to convey hydrogen fuel, with a space defined between the outer pipe assembly 30a and the inner pipe section 30b that provides a thermal barrier between the hydrogen fuel and the temperature in the wing box 20, thereby reducing heat transfer to maintain the low temperature of the hydrogen fuel. The rigid inner and outer pipe sections 31a, 31b may comprise or be formed of metal, e.g. stainless steel.

The hydrogen fuel may be a gaseous hydrogen fuel or a liquid hydrogen fuel. In examples in which the hydrogen fuel is a gaseous hydrogen fuel, the space between the outer pipe assembly 30a and the inner pipe section 30b may comprise nitrogen gas or another inert gas. The inert gas may have a high concentration (e.g. 98% or 99%) so as to prevent any reaction of the gaseous hydrogen with oxygen. In examples in which the hydrogen fuel is a liquid hydrogen fuel, the space between the outer pipe assembly 30a and the inner pipe section 30b may comprise a vacuum. The vacuum reduces heat transfer between the inner and outer pipe sections 31a, 31b.

The protruding portion 26a may be solid, or thermal insulation between the outer pipe assembly 30a and the rib 10 may be further enhanced by making the protruding portion 26a hollow.

In the example shown in FIG. 5, the flanges 28 each extend around a half-circumference of the aperture 11, so as to envelope the pipe assembly 30a, 30b, and are joined by fasteners 19a. However, it will be appreciated that the flanges 28 may be of any suitable configuration. For example, a single flange may extend around the full circumference of the pipe assembly 30a, 30b or the flange(s) may extend around only a portion of the circumference of the pipe assembly 30a, 30b.

As shown in FIG. 6, the flanges 28 may be located on a single side of the rib 10, with the recessed portion 27 of the fixture arrangement integrally formed. In alternative examples, a flange may be attached on both sides of the rib 10, so that the recessed portion 27 is formed of two or more sections.

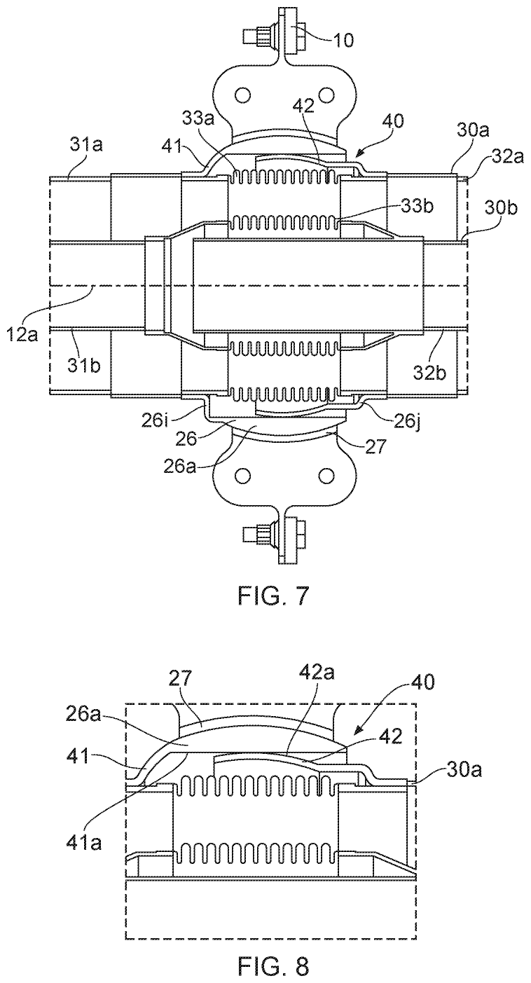

In the embodiment of FIGS. 7 and 8, the outer pipe assembly 30a comprises a first rigid outer pipe section 31a, and a flexible outer pipe section 33a that extends between the first rigid outer pipe section 31a and a second rigid outer pipe section 32a.

Similarly the inner pipe section 30b of FIG. 6 is replaced by an inner pipe assembly 30b comprising a first rigid inner pipe section 31b, and a flexible inner pipe section 33b that extends between the first rigid inner pipe section 31b and a second rigid inner pipe section 32b.

Each flexible pipe section 33a, 33b facilitates relative moment between the first and second rigid pipe sections 31a, 31b; 32a, 32b. The movement may be axial and/or rotational. In this manner, load transfer between the pipe assembly 30a, 30b and the rib 10 is reduced. For instance, if the pipe assembly 30a, 30b comprised a continuous rigid pipe section (not shown), at least some of the loads on the pipe assembly 30a, 30b caused by twisting and/or bending of the wing 3 may be transferred from the pipe assembly 30a, 30b to the rib 10, and thereby require additional strengthening of the rib 10. With the present arrangement, the load transfer is reduced or mitigated by the flexible pipe section 33a, 33b providing for relative movement between the first and second rigid pipe sections 31a, 31b; 32a, 32b.

Each flexible pipe section 33a, 33b is preferably located at the plane of the rib 10, such as shown in FIG. 7. As such, at least a portion of each flexible pipe section 33a, 33b extends either side of the plane of the rib 10. By ensuring the flexible pipe section is located at the plane of the rib 10, any relative bending of the second pipe section 32a, 32b with respect to the first pipe section 31a, 32b occurs either side of the plane of the rib 10. Alternatively, a first flexible pipe section and a second flexible pipe section may be located either side of the plane of the rib 10.

Each flexible pipe section 33a, 33b may be a bellows pipe or other suitable arrangement for absorbing movements in the pipe assemblies 30a, 30b.

The flexible outer pipe section 33a of the outer pipe assembly 30a may be integrally formed with the respective first and second rigid outer pipe sections 31a, 32a of the outer pipe assembly 30a. The flexible inner pipe section 33b of the inner pipe assembly 30b may be integrally formed with the respective first and second rigid inner pipe sections 31b, 32b of the inner pipe assembly 30b. In other words, the outer and inner pipe assemblies 30a, 30b may be continuous across the rib 10 and absent of any disassemblable couplings.

Each flexible pipe section 33a, 33b may be formed of metal, e.g. stainless steel. Each flexible pipe section 33a, 33b may be welded to the respective first and second rigid pipe sections 31a. 31b; 32a, 32b. Each flexible pipe section 33a, 33b may be a bellows arrangement comprising a series of undulations, such as shown in FIGS. 7 and 8. The undulations may have a constant wall thickness. Alternatively, the flexible pipe section 33a, 33b may be a braided pipe arrangement.

In examples in which the outer pipe assembly 30a include a flexible outer pipe section 33a, at least one of the outer pipe sections 31a, 32a, 33a of the outer pipe assembly 30a is fixed relative to the rib 10, so as to prevent unintended movement of the pipe assembly 30a along the wing box 20. In the example shown in FIG. 7, the first rigid outer pipe section 31a is fixed relative to the rib 10 and the second rigid outer pipe section 32a and flexible outer pipe section 33a are moveable relative to the rib 10. Alternatively, the second rigid outer pipe section 32a or flexible outer pipe section 33a may be fixed relative to the rib 10.

To accommodate the relative movement between the rigid outer pipe sections 31a, 32a, the sleeve 26 may be formed of a first sleeve portion 26i and a second sleeve portion 26j.

To ensure that the outer pipe assembly 30a maintains a substantially fixed distance from the rib 10, and in particular from the aperture 11 of the rib 10, the fixture arrangement 25 may comprise a spacing arrangement 40. An example of such a spacing arrangement 40 is shown in FIGS. 7 and 8.

The spacing arrangement 40 may comprise a first joint section 41 fixedly attached to the first rigid outer pipe section 31a of the outer pipe assembly 30a and a second joint section 42 fixedly attached to the second rigid outer pipe section 32a of the outer pipe assembly 30a (e.g. via the sleeve portions 26i, 26j). The first joint section 41 and the second joint section 42 overlap at the plane of the rib 10. The first joint section 41 is configured to contact the second joint section 42 and maintain the contact between the first and second joint sections 41, 42 during relative movement between the first rigid outer pipe section 31a and the second rigid outer pipe section 32a (e.g. axial movement or rotational movement).

FIG. 8 shows a close-up view of the spacing arrangement 40, in which the first joint section 41 includes a straight profile 41a when viewed in cross-section as in FIG. 8, and the second joint section 42 includes a curved profile 42a, when viewed in cross-section as in FIG. 8, which contacts the straight profile 41a of the first joint section 41. A bearing surface is defined between the first and second joint sections 41, 42 such that relative axial and/or rotational movement between the first and second rigid pipe sections 31a, 31b; 32a, 32b is facilitated whilst maintaining a clearance distance between the second rigid outer pipe section 32a of the outer pipe assembly 30a and the fixture arrangement 25.

As the curved profile 42a of the second joint section 42 contacts a straight profile 41a of the first joint section 41, the second joint section 42 is able to facilitate rotation of the second rigid pipe section 32a, 32b relative to the first rigid pipe section 31a, 31b whilst preventing a clash between the second rigid pipe section 32a and the fixture arrangement 25.

Whilst the examples shown in FIGS. 5 to 8 provide for rotation of the pipe assembly 30a, 30b about three perpendicular axes 12a, 12b, 12c, it will be appreciated that other examples may provide rotation about one or two perpendicular axes 12a, 12b, 12c.

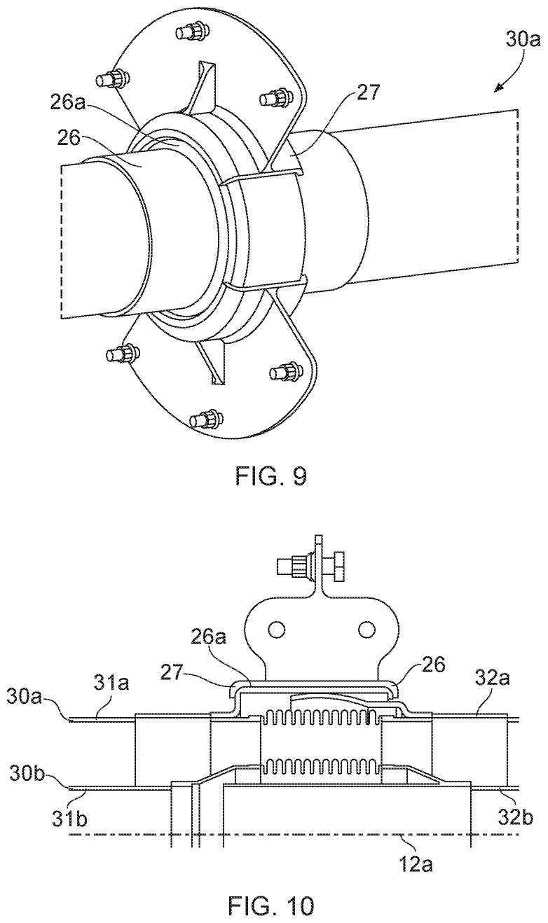

FIGS. 9 and 10 show an example in which the sleeve 26 has a cylindrically shaped protruding portion 26a, with the recessed portion 27 having a corresponding profile such that the outer pipe assembly 30a may rotate about the longitudinal axis 12a of the pipe assembly 30a, but substantially prevents rotation about the transverse axes 12b, 12c parallel to the plane of the rib 10. This allows the loads due to twisting of the wing 3, which may otherwise transfer to the pipe assembly 30a, to be reduced or mitigated.

The bearing surfaces in FIGS. 9 and 10 each have a generally cylindrical shape which allows rotation of the pipe assembly relative to the rib about the longitudinal axis 12a extending in the longitudinal direction. The generally cylindrical shape of the bearing surfaces also restricts rotation of the pipe assembly relative to the rib about two perpendicular axes 12b, 12c, wherein the two perpendicular axes are perpendicular to each other and perpendicular to the longitudinal axis 12a.

As in the embodiments of FIGS. 6 and 7 (with a spherical bearing) the bearing surfaces in FIGS. 9 and 10 are also shaped to provide stop features which restrict movement of at least a portion of the pipe assembly in the longitudinal direction relative to the rib 10.

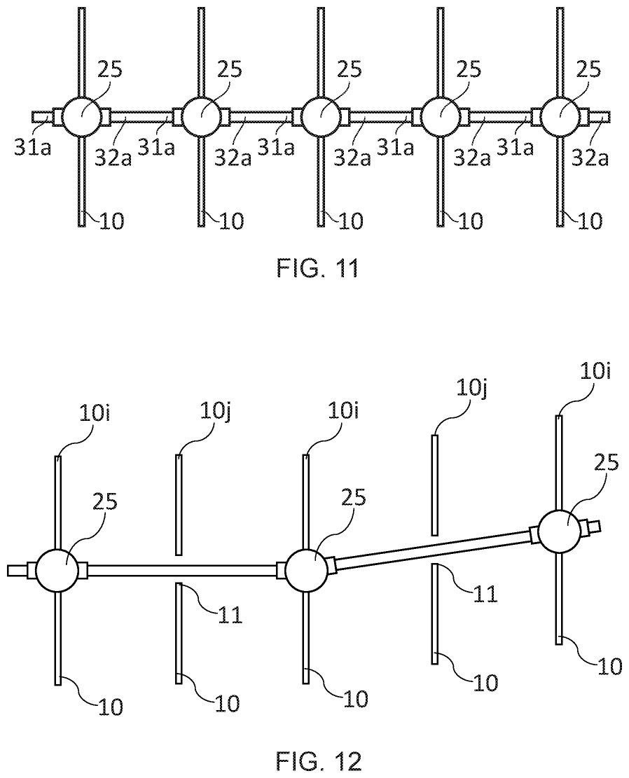

The wing 3 may comprise a plurality of ribs 10a, 10b, 10c within the wing box 20, such as shown in FIG. 3. Each rib may comprise corresponding a fixture arrangement 25 coupling the outer pipe assembly 30a to the rib. FIG. 11 shows an example in which a fixture arrangement 25 is located at each rib 10 in the wing box 20. Similarly, a flexible pipe section 33a, 33b may be located at the plane of each rib 10.

In some examples, it may not be necessary to provide a fixture arrangement 25 at each rib 10. For example, the size of the aperture 11 and the expected loading on the pipe assembly 30a, 30b may be such that a first set of ribs 10i may include fixture arrangements 25, whilst a second set of ribs 10j are absent a fixture arrangement 25. At least some ribs 10 of the second set of ribs 10j may be located between ribs 10 of the first set of ribs 10i, such as shown in FIG. 12. Similarly, a flexible pipe section 33a, 33b may be located at the plane of the first set of ribs 10i and not the second set of ribs 10j.

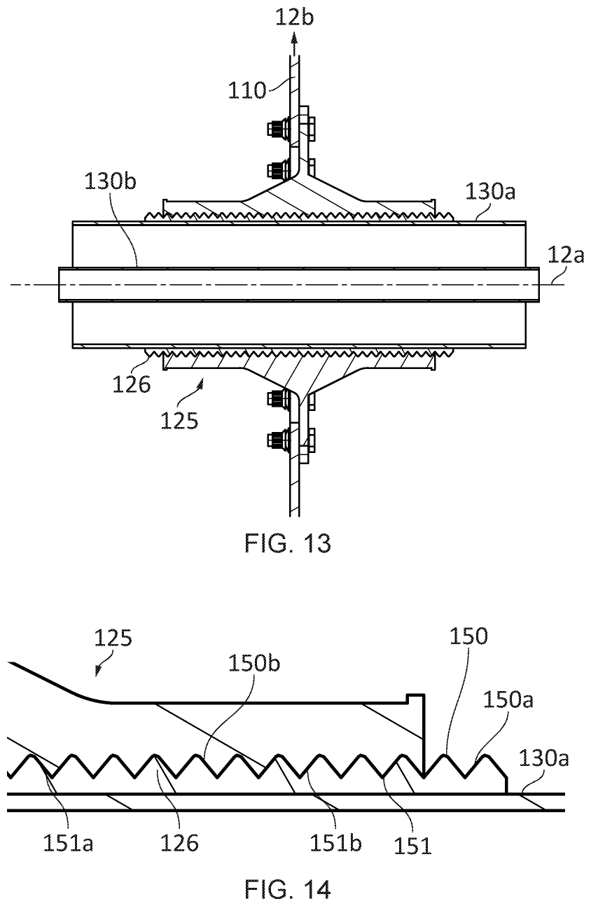

The aircraft assembly of FIG. 13 comprises a rib 110 with an aperture and a pipe assembly extending through the aperture. The pipe assembly comprises a rigid outer pipe section 130a, a sleeve 126, and a rigid inner pipe section 130b. The inner pipe section 130b is enveloped by the outer pipe section 130a. The inner pipe section 130b is configured to convey liquid or gaseous hydrogen fuel. The pipe assembly has a longitudinal axis 12a extending in a longitudinal direction.

Each part of the pipe assembly extends through the aperture in the rib 110, i.e. the outer pipe section 130a, the sleeve 126 and the inner pipe section 130b.

Each pipe section (i.e. the outer pipe section 130a and the inner pipe section 130b) extends continuously through the aperture in the rib without requiring any joints (static or dynamic) which could provide a leak path.

The sleeve 126 may be formed separately and mounted to the outer pipe section 130a. Alternatively the sleeve 126 may be formed integrally with the outer pipe section 130a, so the outer pipe section and the sleeve provide a single piece assembly.

Optionally the sleeve 125 is fixed to the outer pipe section 130a, for instance by an adhesive, by welding or by fasteners.

Optionally the sleeve 126 is formed of a lower friction material than the outer pipe section 130a. For instance the outer pipe section 130a may be formed of metal e.g. stainless steel, and the sleeve 126 may be formed of a polymer, e.g. Nylon.

Optionally the sleeve 126 comprises a substantially electrically non-conductive material, such as a polymer material, configured to electrically isolate the fixture arrangement 125 from the outer pipe section 130a.

The sleeve 126 comprises a set of inner ridges 150 spaced apart in the longitudinal direction. Note that the inner ridges 150 are circular and un-connected-i.e. they do not form a continuous helical thread.

The pipe assembly is rotatably coupled to the rib by a fixture arrangement 125. The fixture arrangement 125 is configured to restrict movement of the pipe assembly 130a, 130b, 126 in the longitudinal direction relative to the rib 110 and allow rotation of the pipe assembly 130a, 130b, 126 relative to the rib 110 about the longitudinal axis 12a.

In this example the fixture arrangement 125 is configured to restrict movement of all parts of the pipe assembly (i.e. the outer pipe section 130a, the sleeve 126 and the inner pipe section 130b) in the longitudinal direction relative to the rib 110.

Also the fixture arrangement 125 is configured to allow rotation of all parts of the pipe assembly (i.e. the outer pipe section 130a, the sleeve 126 and the inner pipe section 130b) about the longitudinal axis 12a relative to the rib 110.

The fixture arrangement 125 comprises a set of outer ridges 151 spaced apart in the longitudinal direction. Like the inner ridges 150, the outer ridges 150 are circular and un-connected—i.e. they do not form a continuous helical thread.

The sets of ridges 150, 151 interlock with each other to restrict movement of the pipe assembly in the longitudinal direction relative to the rib 110. The ridges have a triangle-shaped prolife, with angled left and right-hand sides 150a, 150b; 151a, 151b. Other shaped profiles are possible for the ridges, such as square or sinusoidal.

The inner ridges 150 of the sleeve 126 act as stop members configured to engage with the outer ridges 151 of the fixture arrangement 125 to restrict movement of the pipe assembly in the longitudinal direction relative to the rib. The left-hand sides 150a of the inner ridges 150 provide first stop features configured to engage with the right-hand sides 151b of the outer ridges 151 to restrict movement of the pipe assembly in the longitudinal direction relative to the rib to the left. Similarly the right-hand sides 150b of the inner ridges 150 provide second stop features configured to engage with the left-hand sides 151a of the outer ridges 151 to restrict movement of the pipe assembly in the longitudinal direction relative to the rib to the right.

The fixture arrangement 125 may be configured to restrict movement of at least a portion of the pipe assembly in the longitudinal direction relative to the rib 110 with play no greater than 10 mm, or with play no greater than 5 mm, or with play no greater than 2 mm, or with play no greater than 1 mm.

The inner ridges 150 provide an inner bearing surface, and the outer ridges 151 provide an outer bearing surface. The correspondingly curved bearing surfaces form a bearing therebetween so as to allow the rotation of the pipe assembly relative to the rib.

The inner and outer bearing surfaces each have a generally cylindrical shape which allows rotation of the pipe assembly relative to the rib about the longitudinal axis 12a, and which restricts rotation of the pipe assembly relative to the rib about two perpendicular axes (labelled 12b and 12c), wherein the two perpendicular axes 12b, 12c are perpendicular to each other and perpendicular to the longitudinal axis 12a.

The fixture arrangement 125 is formed in two halves 125a, 125b, with flanges 128 which are bolted to the rib 110 by fasteners 119 shown in FIG. 16. The two halves 125a, 125b are brought together and joined by fasteners 119a. The fixture arrangement 125 may be made of corrosion-resistant steel.

In this case there are thirty-five inner ridges 150 and thirty-one outer ridges 151, although the number of ridges may vary. The ridged arrangement provides an opportunity for incremental positional adjustment to account for installation tolerance build up. In the example of FIG. 13 the sleeve 126 is lined up centrally relative to the fixture arrangement 125, but before the halves 125a, 125b of the fixture arrangement are brought together during installation, the pipe assembly can be shifted to the left or right relative to the fixture arrangement 125, by increments based on the pitch of the ridges 150, 151.

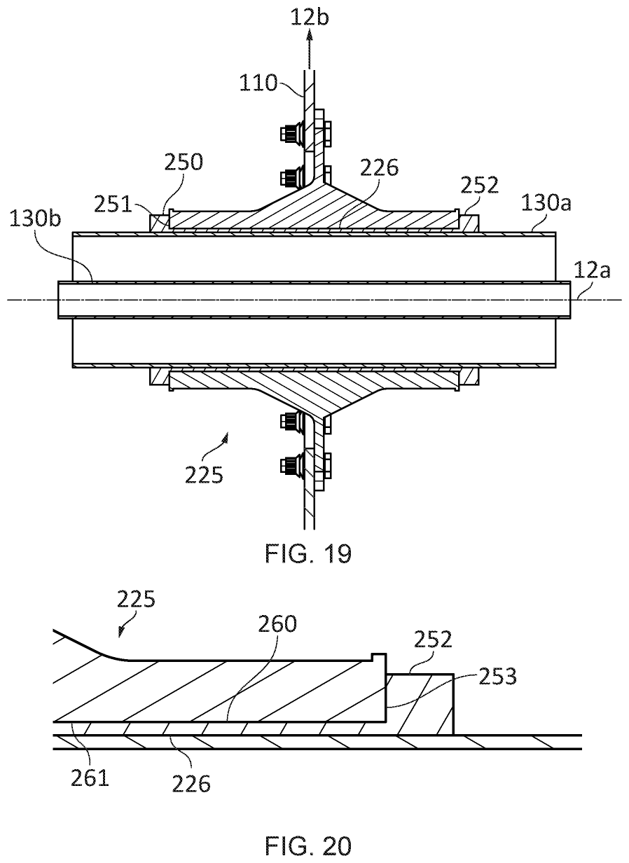

The aircraft assembly of FIG. 19 is similar to the previous embodiment, so the same numbers are used to indicated equivalent features and only the differences will be described.

The sleeve 226 has a first flange 250 configured to engage with the left end 251 of the fixture arrangement 225 to restrict movement of the pipe assembly in the longitudinal direction relative to the right. The sleeve 226 also has a second flange 252 configured to engage with the right end 253 of the fixture arrangement 225 to restrict movement of the pipe assembly in the longitudinal direction relative to the left.

The fixture arrangement 225 may be configured to restrict movement of at least a portion of the pipe assembly in the longitudinal direction relative to the rib 110 with play no greater than 10 mm, or with play no greater than 5 mm, or with play no greater than 2 mm, or with play no greater than 1 mm.

Correspondingly curved bearing surfaces 260, 261 of the sleeve 226 and the fixture arrangement 225 form a bearing therebetween so as to allow the rotation of the pipe assembly relative to the rib. The bearing surfaces 260, 261 each have a generally cylindrical shape which allows rotation of the pipe assembly relative to the rib about the longitudinal axis 12a, and which restricts rotation of the pipe assembly relative to the rib about two perpendicular axes 12b, 12c in the plane of the rib 110. The two perpendicular axes 12b, 12c are perpendicular to each other and perpendicular to the longitudinal axis 12a.

The fixture arrangement 225 is formed in two halves 225a, 225b, with flanges 228 which are bolted to the rib by fasteners 119 shown in FIG. 22. The two halves 225a, 225b are brought together and joined by fasteners 119a. The fixture arrangement 225 may be made of corrosion-resistant steel.

In contrast with the previous embodiment, this embodiment does not provide an opportunity for incremental positional adjustment to account for installation tolerance build up.

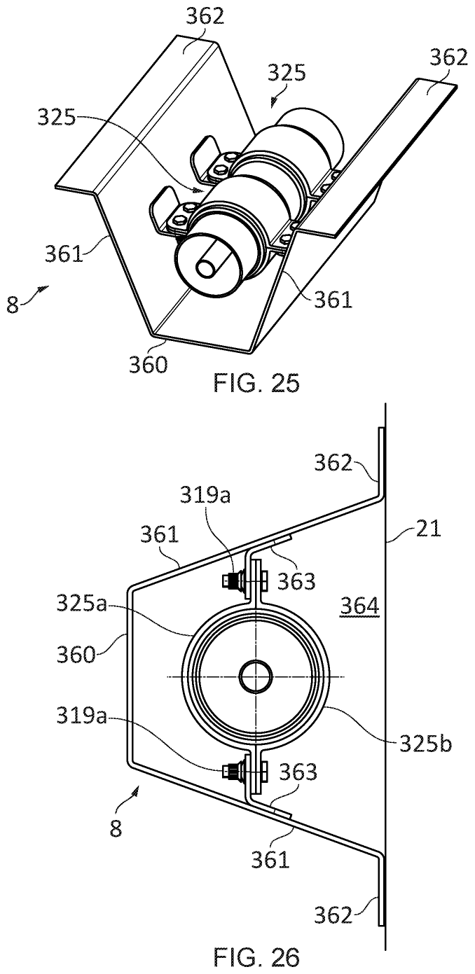

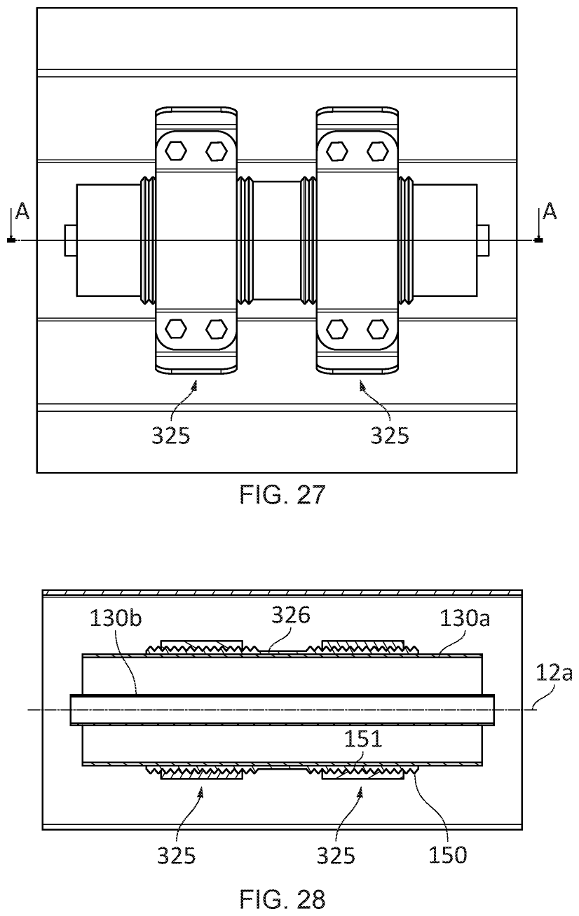

Referring back to FIG. 2, each cover 21, 22 has an inner surface carrying a series of stiffeners 8 which run in a spanwise direction along the wing. FIGS. 25-28 show a further embodiment of the invention in which a pipe assembly is coupled to one of the stiffeners 8 carried by the upper cover 21, instead of being coupled to a rib.

Certain elements of the aircraft assembly of FIGS. 25-28 have equivalents in the embodiment of FIG. 13, and are given the same reference number.

The aircraft assembly comprises a stiffener 8; and a pipe assembly rotatably coupled to the stiffener by a pair of identical fixture arrangements 325.

A sleeve 326 (shown most clearly in FIG. 28) is fixed to the outer pipe section 130a, for instance by an adhesive, by welding or by fasteners. The sleeve 326 is similar to the sleeve 126 in FIG. 13, but with two sets of inner ridges 150, each interlocked with the outer ridges 151 of a respective one of the fixture arrangements 325.

Each fixture arrangement 325 is formed in two halves 325a, 325b shown in FIG. 26. The two halves 325a, 325b are brought together and joined by fasteners 319a.

The stiffener 8 has an omega shaped cross-section, with a crown 360, a pair of webs 361, and a pair of feet 362. The feet 362 are joined to the upper cover 21 as shown in FIG. 26. Each fixture arrangement 325 is attached to the webs of the stiffener 8 by brackets 363.

The stiffener 8 and upper cover 21 together form a duct 364 which encloses the pipe assembly as shown in FIG. 26, thereby acting as a third wall for further leak containment.

The pipe assembly 130a, 130b, 326 is rotatably coupled to the stiffener 8 by the fixture arrangements 325, which are each configured to restrict movement of the pipe assembly in the longitudinal direction relative to the stiffener 8, and allow rotation of the pipe assembly relative to the stiffener about the longitudinal axis 12a.

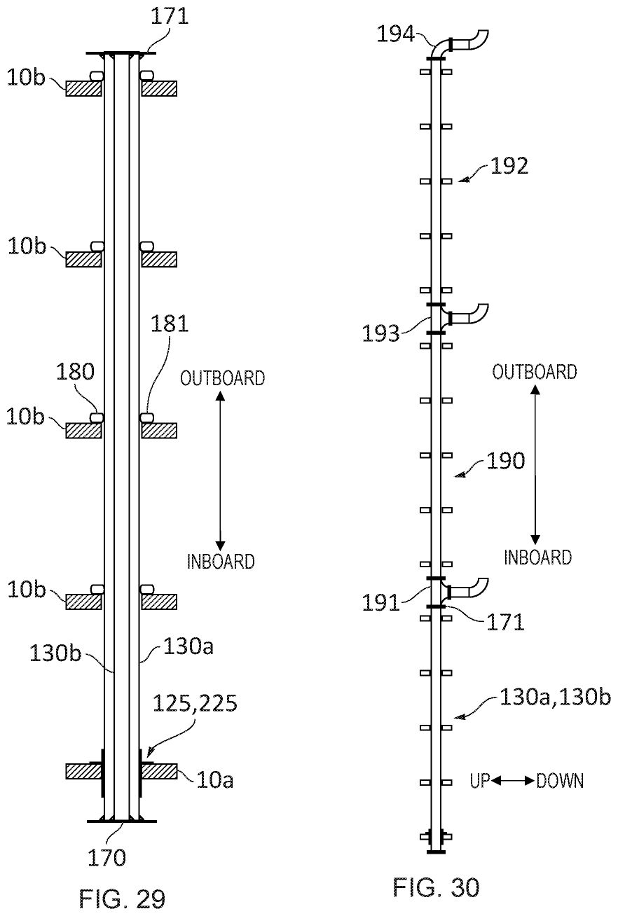

FIG. 29 is a schematic cross-sectional view showing the inboard rib 10a at the root of the wing, and a series of four of the mid-span ribs 10b.

The outer pipe section 130a and the inner pipe section 130b extend continuously from an inboard flange 170 at one end to an outboard flange 171 at the other end.

Spacers (not shown) may be fitted between the outer pipe section 130a and the inner pipe section 130b to keep the inner and outer pipe sections coaxial and transmit radial loads between them. The spacers may be distributed along the length of the pipe assembly.

The inboard flange 170, which is inside the fuselage, attaches the pipe assembly to a hose or further pipe assembly (not shown) which couples the pipe assembly to a fuel tank (not shown) containing gaseous or liquid hydrogen.

The outboard flange 171 attaches the pipe assembly to further pipe assemblies which lead to one or more engines (not shown).

The pipe assembly 130a, 130b is coupled to the inboard rib 10a by a fixture arrangement which may be either one of the fixture arrangements 125, 225 described above, or one of the fixture arrangements 25 described earlier.

The pipe assembly 130a, 130b passes through apertures in each of the four mid-span ribs 10b. The pipe assembly 130a, 130b is coupled to each mid-span rib 10b by a respective fairlead assembly which restricts translational movement of the pipe assembly in the plane of the rib 10b (i.e. radial movement in the directions of the transverse axes 12b, 12c), but allows translational movement in the longitudinal direction (i.e. the direction of the longitudinal axis 12a) and rotation about all three perpendicular axes 12a, 12b, 12c.

More specifically, each fairlead arrangement comprises a pair of C-shaped parts 180, 181 which are brought together around the pipe assembly to lightly grip the outer pipe section 130a, before being fastened to the rib 10b. Each part has an internal face which grips the pipe assembly.

Each internal face is rounded in the spanwise direction, as can be seen in FIG. 29. This enables the pipe assembly to rotate relative to the fairlead arrangement about the axes 12b, 12c by rolling around the rounded internal faces. This accommodates bending and/or twisting of the wing without transmitting loads into the mid-span ribs.

Each part 180, 181 of the fairlead arrangement is formed with a low-friction material, which enables the pipe assembly to easily translate in the longitudinal direction, and rotate about the longitudinal axis 12a, with a low-friction sliding interaction with the internal face of the fairlead arrangement. This further accommodates bending and/or twisting of the wing without transmitting loads into the mid-span ribs 10b.

The outlet from the fuel tank may have a T-junction fitting (not shown) with two outlets: one outlet leading to a pipe assembly in the port wing 2 and the other outlet leading to a pipe assembly in the starboard wing 3. Desirably the T-junction fitting is fixed so that it cannot move relative to the fuselage 4 in the port or starboard direction. For this reason it is advantageous to place the fixture arrangement 125, 225 etc. (which fixes the pipe assembly in the longitudinal direction 12a) at the inboard rib 10a at the root of the wing, rather than at a mid-span rib 10b which is positioned outboard of the inboard rib 10a.

Since the fixture arrangement 125, 225 is at the root of the wing, there is relatively little twisting or bending so the restriction of rotation about the rib axes 12b, 12c is acceptable.

FIG. 30 is a schematic view showing how the pipe assembly of FIG. 25 may be attached to further pipe assemblies running along the span of the wing. The pipe assembly 130a, 130b nearest the wing root is attached to a mid-span pipe assembly 190 by a first T-junction fitting 191, which is connected in turn to an outboard pipe assembly 192 by a second T-junction fitting 193. The T-junction fittings 191, 193 are coupled to respective first and second engines (not shown) via flexible hoses, and the outboard pipe assembly 192 is coupled to a third engine (not shown) by an S-shaped pipe fitting 194 and flexible hose.

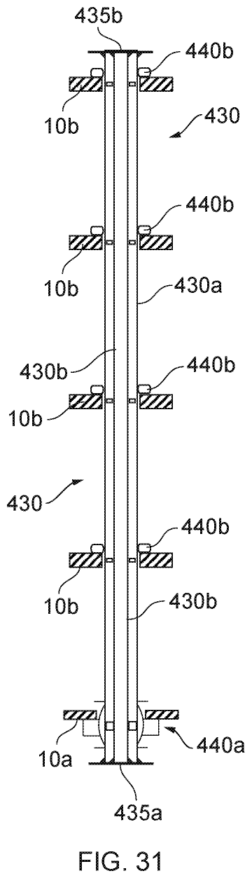

FIG. 31 is a schematic cross-sectional view showing an aircraft pipe assembly 430 similar to the aircraft pipe assemblies described above. Identical features are given the same reference number. The pipe assembly 430 extends through the inboard rib 10a at the root of the wing 3, and a series of four of the mid-span ribs 10b. The pipe assembly 430 passes through the plane of each rib 10a, 10b. The pipe assembly 430 may pass through an aperture in each of the ribs 10a, 10b.

The pipe assembly 430 comprises a double-walled pipe assembly with an outer pipe section 430a and an inner pipe section 430b. The inner pipe section 430b is within or enveloped by the outer pipe section 430a. The inner pipe section 430b is arranged to carry cryogenic fuel, such as liquid hydrogen. To maintain the cryogenic fuel at cryogenic temperatures, it is important to minimise thermal losses from the pipe assembly 430. To achieve this, the interspace between the outer pipe section 430a and the inner pipe section 430b may be held at a vacuum pressure.

Pipe spacers may be fitted between the outer pipe section 430a and the inner pipe section 430b to keep the outer and inner pipe sections 430a, 430b coaxial and transmit radial loads between them. The pipe spacers surround the inner pipe section 430a and can be distributed at intervals along the length of the pipe assembly 430.

The pipe assembly 430 is coupled to each rib 10a, 10b by a fixture arrangement 440a or 440b.

The fixture arrangement 440a at the inboard rib 10a is configured to restrict translational movement of the pipe assembly 430 in the longitudinal direction relative to the rib 10a, restrict translational movement of the pipe assembly 430 in the plane of the rib 10a (i.e. radial movement away from a longitudinal axis of the pipe assembly 430), and allow rotation of the pipe assembly 430 relative to the rib 10a about the longitudinal axis. By restricting movement of the pipe assembly 430 along the longitudinal axis at one or more points (in this case only the inboard rib 10a), the pipe assembly 430 is prevented from sliding freely through the wing box.

The fixture arrangement 440b at each mid-span rib 10b is configured to restrict translational movement of the pipe assembly 430 in the plane of the rib 10b (i.e. radial movement away from a longitudinal axis of the pipe assembly 430), but allows translational movement in the longitudinal direction (i.e. the direction of the longitudinal axis) and rotation about three perpendicular axes.

In this manner, the pipe assembly 430 is simply supported by the fixture arrangements 440a, 440b such that shear loads are transmitted from the aircraft wing structure, through the ribs 10a, 10b, to the pipe assembly 430, whilst bending loads are minimised or mitigated. This can be particularly important in cryogenic applications due to the increased thickness of the fuel pipes 430a, 430b generally required compared to fuel pipes in non-cryogenic applications.

The pipe sections 430a, 430b may be formed of relatively stiff materials such as metals, and for example stainless steel.

The fixture arrangement 440a provides a ‘master’ axial pipe location, and all other fixture arrangements 440b support the pipe assembly 430 radially but allow sliding in the axial direction, thus enabling the pipe assembly 430 to expand/contract thermally.

Optionally the pipe sections 430a, 430b may be formed from a metal with a low thermal expansion coefficient to reduce such thermal expansion/contraction.

The pipe assembly 430 has a flange fitting 435a at its inboard end, which may be connected to further pipework (not shown) leading to a fuel tank system.

The pipe assembly 430 also has a flange fitting 435b at its outboard end, which may be connected to further pipework (not shown) leading to an engine of the aircraft, or to a refuel coupling or vent outlet.

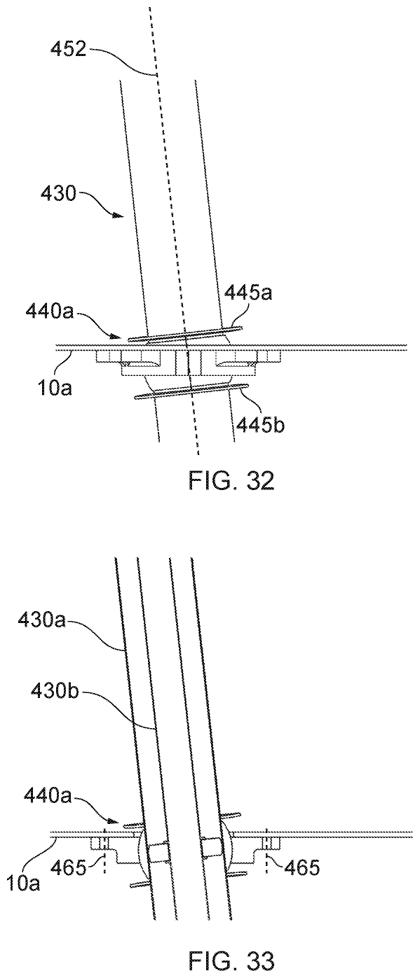

FIGS. 32-36 show an example of the fixture arrangement 440a at the inboard rib 10b. As shown in FIG. 3, the ribs include an inner-most inboard rib 10a located at a root of the wing box, an outer-most outboard rib 10c at a tip of the wing box, and one or more mid-span ribs 10b between the inner-most and outer-most ribs. In this example, the fixture arrangement 440a is at the inboard rib 10b, but in other embodiments the fixture arrangement 440a may be at one or more of the mid-span ribs 10b.

The fixture arrangement 440a comprises a spherical bearing between the pipe assembly 430 and the aircraft structure (in this case, the rib 10a).

The spherical bearing comprises a ball mounted to the pipe assembly 430, and a housing coupled to the rib 10a.

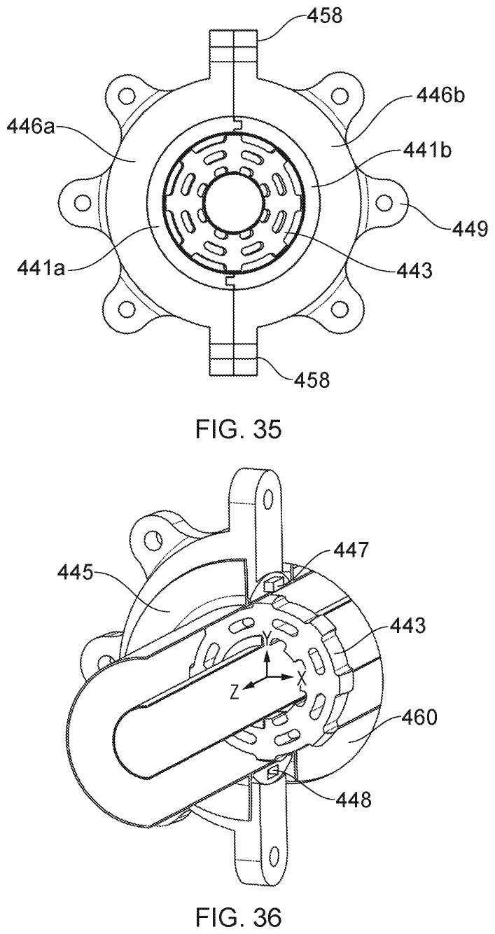

The ball comprises an assembly of two ball parts 441a, 441b which are distributed around a circumference of the pipe assembly as shown in FIG. 35. As shown in FIG. 36, each ball part 441a, 441b comprises a projection 447 which fits into a recess 448 of the other ball part.

As shown in FIG. 36, the pipe assembly 430 passes through an aperture 460 in the rib 10a.

The ball parts 441a, 441b may be fixed to the pipe assembly 430, so there is little or no movement between the ball and the pipe assembly. For example the ball parts 441a, 441b may be metallic parts which are welded to the outer pipe section 430a.

As shown in FIG. 35, the housing comprises an assembly of two housing parts 446a, 446b which are distributed around a circumference of the pipe assembly. Each housing part 446a, 446b has lugs 449 shown in FIG. 35 which are attached to the rib 10a by fasteners 465, such as bolts, shown schematically in FIG. 33. Each housing part 446a, 446b also has a pair of lugs 458 which are attached to the lugs 458 of the other housing part by fasteners, such as bolts (not shown).

Providing a two-part housing arrangement 446a, 446b enables a positive fit and location (both axially and radially) which is mechanically robust.

The housing parts 446a, 446b may be metallic or GFRP (glass fibre reinforced plastic) materials—for example G10 GFRP or G11 GFRP. Optionally the housing parts 446a, 446b comprise a thermoplastic material.

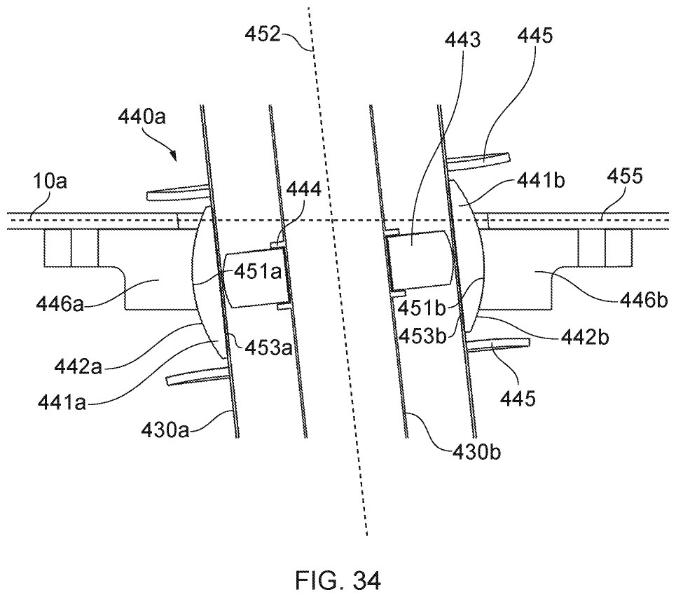

As shown in FIG. 34, the ball 441a, 441b comprises a convex spherical bearing surface 442a, 442b; and the housing 446a, 446b comprises a concave spherical bearing surface 451a, 451b which mates with the convex spherical bearing surface of the ball.

The spherical bearing is configured to enable the pipe assembly 430 to rotate relative to the rib 10a about three perpendicular axes, labelled X, Y, Z in FIG. 36. The Z axis is a longitudinal axis extending in the longitudinal direction of the pipe assembly, and the X and Y axes are transverse axes extending perpendicular to the longitudinal direction of the pipe assembly. The pipe assembly 430 is relatively rigid, and enabling rotation alleviates stresses induced into the pipe assembly 430 caused by wing flex during flight.

In this case the concave spherical bearing surface 451a, 451b of the housing contacts the convex spherical bearing surface 442a, 442b of the ball, providing a plain bearing with a sliding contact between the spherical bearing surfaces. Providing a two-part housing arrangement 446a, 446b enables a low (or zero) clearance between the spherical bearing surfaces to be achieved.

In an alternative embodiment, the spherical bearing surfaces may have ball-bearings between them, so there is no direct contact between the spherical bearing surfaces.

The rib 10a has a rib plane 455 which may pass through the convex spherical bearing surface 442a, 442b of the ball as shown in FIG. 34.

The pipe assembly 430a, 430b extends in a longitudinal direction which defines a longitudinal axis 452. The angle of the longitudinal axis 452 can vary. In FIG. 31 the longitudinal axis 452 is perpendicular to the rib plane 455, but in FIGS. 32-34 it is inclined at an oblique angle to the rib plane 455.

The spherical bearing is configured to transmit radial load (i.e. load normal to the spherical bearing surfaces 442a, 442b, 451a, 451b) between the pipe assembly 430 and the rib 10a, but such radial load can be transmitted with a ball which is relatively narrow (in the radial sense).

The pipe assembly 430 may optionally include failsafe flanges 445a,b which are welded to the outer pipe 430a on opposite sides of the rib 10a. The failsafe flanges comprise an outboard failsafe flange 445a on an outboard side of the rib 10a, and an inboard failsafe flange 445b on an inboard side of the rib 10a.

In the event of failure of the ball joint caused by a high axial load, then depending on the direction of the axial load either the outboard failsafe flange 445a will come into contact with the rib 10a, or the inboard failsafe flange 445b will come into contact with the housing 446a,b.

The outboard failsafe flange 445a has a diameter greater than the diameter of the aperture 460 in the rib 10a. This ensures that it comes into contact with the rib 10a, rather than passing through the rib 10a, in the event of a failure.

Similarly the inboard failsafe flange 445b has a diameter greater than the concave spherical bearing surface 451a,b of the housing 446a,b . This ensures that it comes into contact with the housing 446a,b rather than passing through the housing 446a,b , in the event of a failure.

In this example there is a a gap between each failsafe flange 445a, 445b and the ball 441a, 441b (the gap may be 2 mm for example). In the event of failure of the weld between the ball and the outer pipe 430a caused by a high axial load, then this gap will close. Depending on the direction of the axial load either the outboard failsafe flange 445a will come into contact with the ball, or the inboard failsafe flange 445b will come into contact with the ball.

In an alternative embodiment, there may be no gap between each failsafe flange 445a,b and the ball 441a,b , so that each failsafe flange 445a,b contacts the ball. In this case optionally there may be no weld between the ball and the outer pipe 430a, and instead the failsafe flanges 445a/b axially constrain the ball to prevent it from moving axially relative to the pipe assembly 430.

FIG. 36 also shows the detail of a pipe spacer 443 which separates the inner and outer pipes 430a, 430b of the pipe assembly 430.

Although the fixture arrangement 440a is relatively complex, it is only required at a single rib 10a, and enables relatively simple fixture arrangements 440b to be used at the other ribs 410b.

In the embodiment above, the ball parts 441a, 441b may be welded to the pipe assembly 430 so there is little or no movement between the ball and the pipe assembly—either axial translation or rotation. In other examples the ball parts 441a, 441b may be free to rotate relative to the pipe assembly 430 about the axis 452, but axially constrained by the failsafe flanges 445a,b which are welded to the outer pipe 430a. In this case the gap between the ball and the flanges 445a,b may be much smaller, or zero (so the ball is in permanent contact with both failsafe flanges 445a,b and the ball is fully constrained axially).

In this case the ball parts 441a, 441b may be a non-metallic material such as GFRP (glass fibre reinforced plastic) materials—for example G10 GFRP or G11 GFRP. Optionally the ball parts 441a, 441b comprise a thermoplastic material.

Whilst the pipe assembly 430 in the present example is described as conveying liquid hydrogen, it will be appreciated that other fuels, and particularly cryogenic fuels, may be adopted. For example, a gaseous hydrogen fuel may be used. In this case, an inert gas may replace the vacuum in the interspace between the outer pipe section 430a and the inner pipe section 430b.

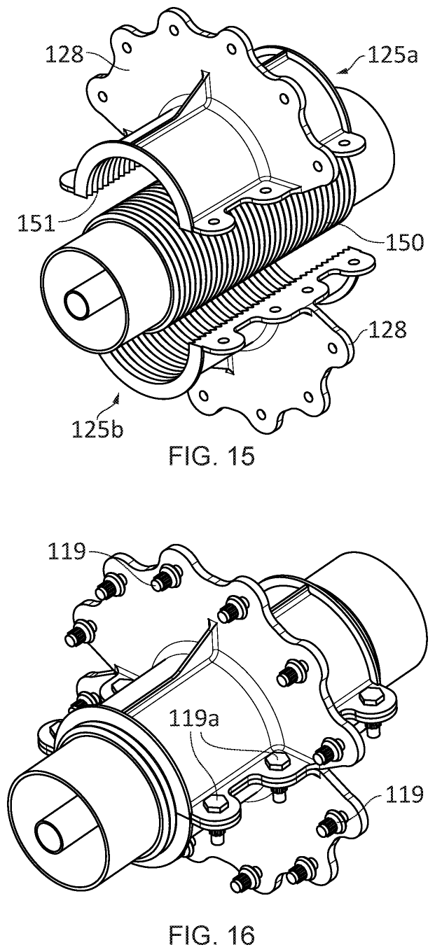

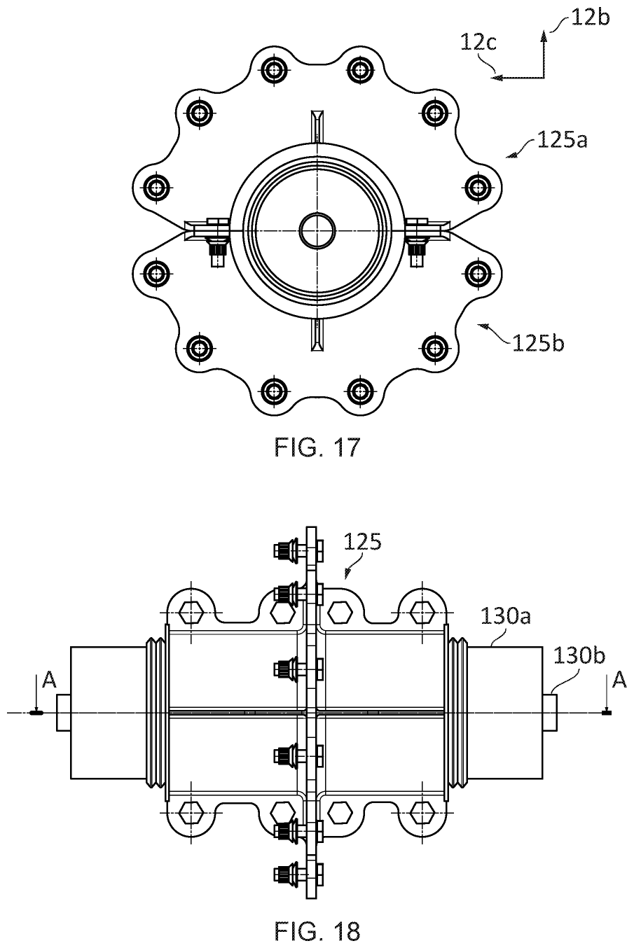

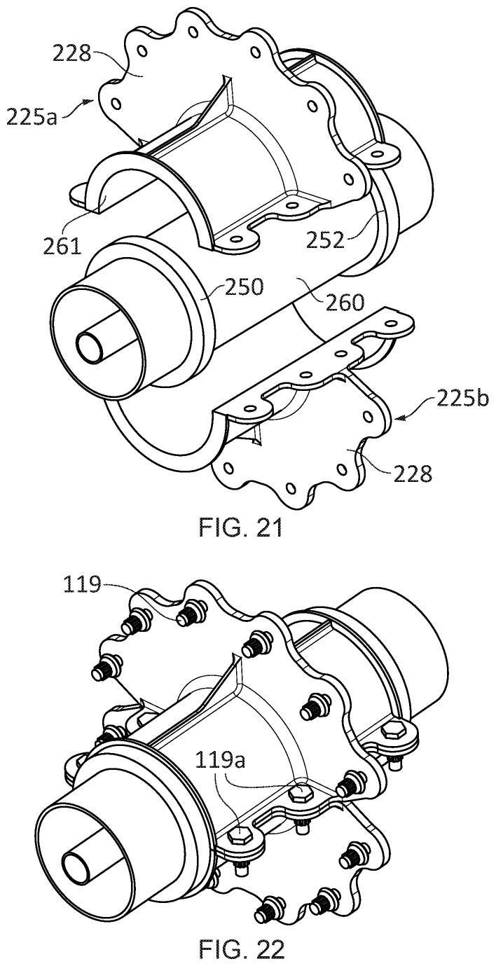

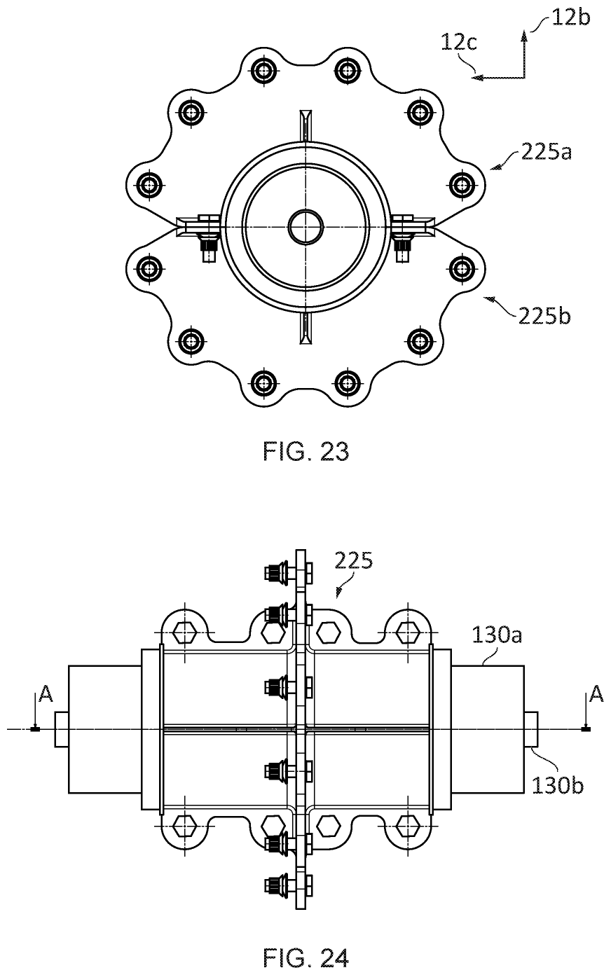

In the embodiments of FIGS. 1-36, the pipe assembly is coupled to a wing structure in a wing 3 of the aircraft by a fixture arrangement 25, 125, 225, 325, 440a. In other embodiments of the invention a similar aircraft pipe assembly may be provided in another part of the aircraft, such as the fuselage 4 or a fairing. In this case the fixture arrangement 25, 125, 225, 325, 440a may couple the pipe assembly to a different aircraft structure, such as a fuselage rib or a longeron.

Where the word ‘or’ appears this is to be construed to mean ‘and/or’ such that items referred to are not necessarily mutually exclusive and may be used in any appropriate combination.

Although the invention has been described above with reference to one or more preferred embodiments, it will be appreciated that various changes or modifications may be made without departing from the scope of the invention as defined in the appended claims.

1. An aircraft assembly comprising:
an aircraft structure; and
a pipe assembly rotatably coupled to the aircraft structure by a fixture arrangement, the pipe assembly extending along a longitudinal direction, the fixture arrangement configured to restrict movement of at least a portion of the pipe assembly in the longitudinal direction relative to the aircraft structure and allow rotation of the pipe assembly relative to the aircraft structure,
wherein the pipe assembly comprises an outer pipe section and an inner pipe section, and the inner pipe section is enveloped by the outer pipe section.

2. The aircraft assembly of claim 1, wherein the fixture arrangement is configured to allow rotation of the pipe assembly, relative to the aircraft structure, about a longitudinal axis extending in the longitudinal direction.

3. The aircraft assembly of claim 1, wherein the fixture arrangement is configured to allow rotation of the pipe assembly, relative to the aircraft structure, about two or three perpendicular axes.

4. The aircraft assembly of claim 1, further comprising curved bearing surfaces forming a bearing therebetween so as to allow the rotation of the pipe assembly relative to the aircraft structure.

5. (canceled)

6. The aircraft assembly of claim 4, wherein the pipe assembly comprises a sleeve mounted to the outer pipe section, wherein the sleeve provides one of the bearing surfaces.

7. (canceled)

8. The aircraft assembly of claim 4, wherein the bearing surfaces can slide relative to each other to allow rotation of the pipe assembly relative to the aircraft structure about a longitudinal axis extending in the longitudinal direction.

9. The aircraft assembly of claim 4, wherein the bearing surfaces are shaped to restrict rotation of the pipe assembly relative to the aircraft structure about two axes perpendicular to the longitudinal direction.

10. The aircraft assembly of claim 4, wherein the bearing surfaces are shaped to provide stop features which restrict movement of at least a portion of the pipe assembly in the longitudinal direction relative to the aircraft structure.

11. The aircraft assembly of claim 4, wherein each bearing surface comprises a set of ridges spaced apart in the longitudinal direction, and the sets of ridges interlock with each other to restrict movement of at least a portion of the pipe assembly in the longitudinal direction relative to the aircraft structure.

12. The aircraft assembly of claim 4, wherein the bearing surfaces each have a generally cylindrical shape which allows rotation of the pipe assembly relative to the aircraft structure about a longitudinal axis extending in the longitudinal direction, and which restricts rotation of the pipe assembly relative to the aircraft structure about two perpendicular axes, wherein the two perpendicular axes are perpendicular to each other and perpendicular to the longitudinal axis.

13. The aircraft assembly of claim 1, wherein the pipe assembly is configured to convey hydrogen fuel.

14. The aircraft assembly of claim 1, wherein the pipe assembly comprises one or more stop members configured to engage with the fixture arrangement to restrict movement of at least a portion of the pipe assembly in the longitudinal direction relative to the aircraft structure.

15. The aircraft assembly of claim 14, wherein each stop member is fixed to the outer pipe section.

16. The aircraft assembly of claim 14, wherein the one or more stop members comprises a first stop feature configured to engage with a first part of the fixture arrangement to restrict movement of at least a portion of the pipe assembly in the longitudinal direction relative to the aircraft structure in a first direction, and a second stop feature configured to engage with a second part of the fixture arrangement to restrict movement of at least a portion of the pipe assembly in the longitudinal direction relative to the aircraft structure in a second direction.

17. The aircraft assembly of claim 16, wherein the first stop feature comprises a first flange and the second stop feature comprises a second flange.

18. The aircraft assembly of claim 16, wherein the one or more stop members comprise a protrusion or recess, the first stop feature comprises a first side of the protrusion or recess and the second stop feature comprises a second side of the protrusion or recess.

19. The aircraft assembly of claim 1, wherein the aircraft structure is a rib with an aperture in the rib; and the pipe assembly extends through the aperture.

20. The aircraft assembly of claim 19, wherein each pipe section extends through the aperture, and the fixture arrangement is configured to restrict movement of the pipe sections in the longitudinal direction relative to the rib and allow rotation of the pipe sections relative to the rib.

21. (canceled)

22. The aircraft assembly of claim 1, wherein the pipe assembly further comprises flanges on opposite sides of the aircraft structure.

23. An aircraft wing comprising the aircraft assembly of claim 1.

24. (canceled)

25. (canceled)
